(19) United States
(12) Patent Application Publication
(10) Pub. No.: US 2021/0162294 A1
(43) Pub. Date: Jun. 3, 2021

(54) GIMBAL SYSTEM, MOBILE PLATFORM AND BATTLE SYSTEM

(71) Applicant: SZ DJI TECHNOLOGY CO., LTD., Shenzhen (CN)

(72) Inventors: Bowen LI, Shenzhen (CN); Bin ZHUANG, Shenzhen (CN); Kunpeng JING, Shenzhen (CN); Huai HUANG, Shenzhen (CN)

(73) Assignee: SZ DJI TECHNOLOGY CO., LTD., Shenzhen (CN)

(21) Appl. No.: 17/172,089

(22) Filed: Feb. 10, 2021

Related U.S. Application Data
(63) Continuation of application No. PCT/CN2018/125836, filed on Dec. 29, 2018.

(51) Int. Cl. A63F 9/02; F16M 11/04; F16M 11/20; H04B 10/50

(52) U.S. Cl. CPC A63F 9/0252; H04B 10/50; F16M 11/2014; F16M 11/04

(57) ABSTRACT

A gimbal system, a mobile platform and a battle system are disclosed. The gimbal system is used for a shooting battle. The gimbal system includes a gimbal and a battle information interactive device, the battle information interactive device 2 is arranged on an outer side surface of the gimbal to send and receive battle information and/or output special effects based on the battle information. The present disclosure may fulfill various interactive functions during a battle and achieve fun. An outer side of the battle information interactive device is not shielded, so that information sending and receiving and/or special effect outputting may be conveniently achieved from and/or by the outside.

### RELATED APPLICATIONS

This application is a continuation application of PCT application No. PCT/CN2018/125836, filed on Dec. 29, 2018, and the content of which is incorporated herein by reference in its entirety.

### TECHNICAL FIELD

The present disclosure relates to the technical field of robots, and in particular to a gimbal system, a mobile platform and a battle system.

### BACKGROUND

With the continuous development of science and technology, automatic control devices such as robots have been used more and more widely, and appear in the field of entertainments and competitions.

Currently, in some competitions, robots may use simulated shooting devices to compete. Usually, robots carry launching devices such as gel ball shooters, and can score points by shooting gel balls at other robots or targets.

However, currently the primary shooting devices for the robots are gel ball shooters, and the scoring and competitive methods are very limited, which affects the fun of battles.

### SUMMARY

The present disclosure provides a gimbal system, a mobile platform and a battle system, which can perform various interactive functions during a battle, and is very interesting.

According to a first aspect, some embodiments of the present disclosure provides a gimbal system for a shooting battle, including a gimbal and a battle information interactive device, wherein the battle information interactive device is provided on an outer side surface of the gimbal, and is used to send and receive battle information and/or output special effects based on the battle information.

According to a second aspect, some embodiments of the present disclosure provides a mobile platform, including a platform main body and the foregoing gimbal system provided on the platform main body, wherein the gimbal system includes a gimbal and a battle information interactive device, and the battle information interactive device is arranged on an outer side surface of the gimbal to send and receive battle information and output special effects based on the battle information.

According to a third aspect, some embodiments of the present disclosure provides a battle system, comprising at least two teams, each of which comprises at least one foregoing mobile platform, wherein the at least one foregoing mobile platform is capable of performing at least one of the following operations by means of a battle information interactive device: sending and receiving battle information, and outputting special effects based on the battle information.

In the gimbal system, the mobile platform and the battle system of the present disclosure, the gimbal system is used for a shooting battle, and specifically includes a gimbal and a battle information interactive device, wherein the battle information interactive device is provided on an outer side surface of the gimbal and is used for performing one or more of the following operations: sending and receiving battle information, and outputting special effects based on the battle information. In this way, the battle information interactive device can be used to perform interactive functions of the gimbal system during a simulated shooting battle, which effectively improves experience and fun of competitions. An outer side of the battle information interactive device is not covered, so that information sending and receiving and/or special effect outputting can be achieved conveniently from and/or by the outside.

### BRIEF DESCRIPTION OF THE DRAWINGS

In order to depict embodiments of the present disclosure or technical solutions in the prior art more clearly, the drawings to be used in the depictions of the embodiments or the prior art will be introduced briefly. It is obvious that the following figures are some exemplary embodiments of the present disclosure, and those skilled in the art could further obtain other figures according to the following figures without involving inventive skills.

FIG. 1 is a schematic structural diagram of a gimbal system according to Embodiment 1 of the present disclosure;

FIG. 2 is a schematic diagram of an internal structure of an infrared sending and receiving assembly in the gimbal system according to Embodiment 1 of the present disclosure;

FIG. 3 is a partially enlarged schematic diagram at “A” shown in FIG. 2;

FIG. 4 is an exploded schematic diagram of a battle information interactive device in a gimbal system according to Embodiment 1 of the present disclosure;

FIG. 5 is a schematic structural diagram of an indicator light in the gimbal system according to Embodiment 1 of the present disclosure.

### DETAILED DESCRIPTION

The embodiments of the present disclosure will be depicted in further detail with reference to the accompanying drawings. The following exemplary embodiments and features may be combined in the case of no conflicting.

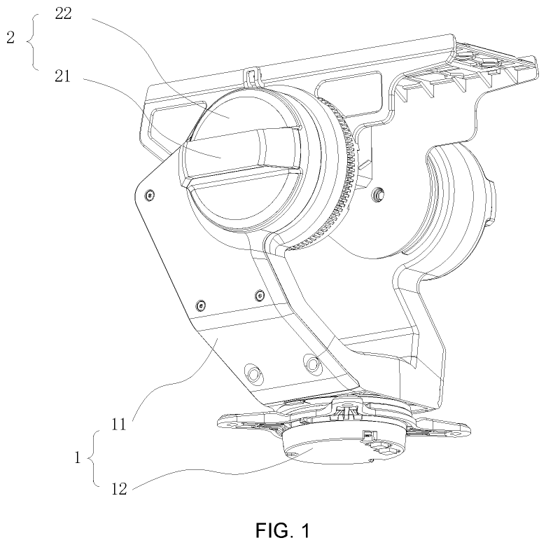

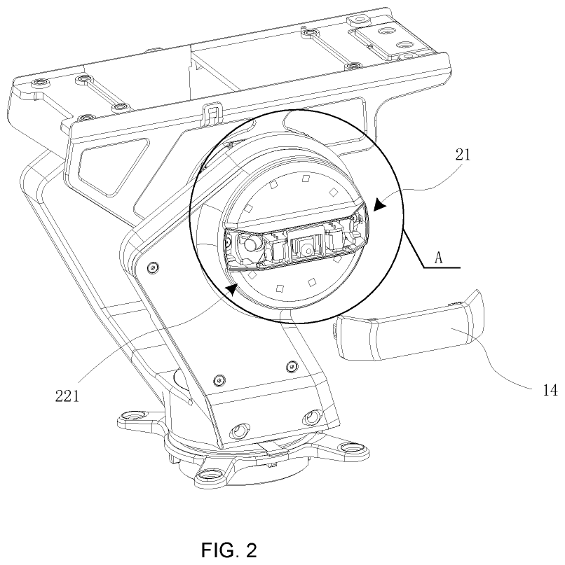

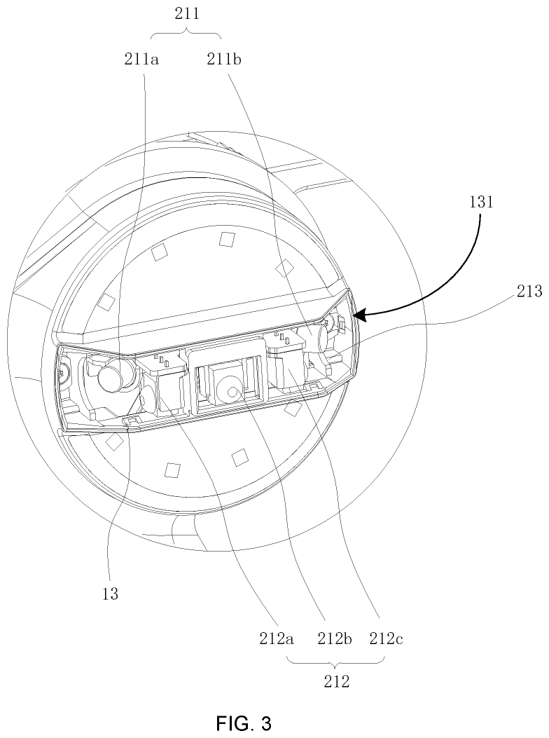

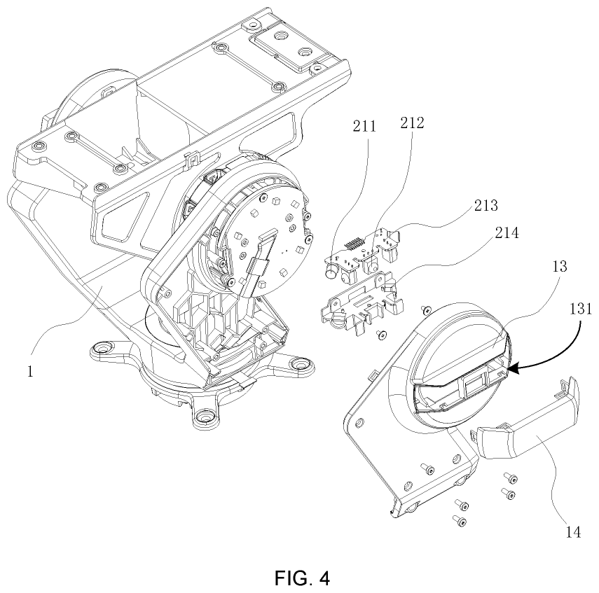

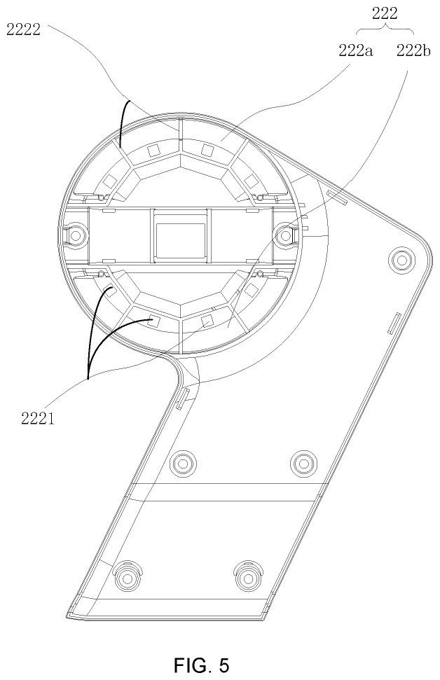

FIG. 1 is a schematic structural diagram of a gimbal system according to Embodiment 1 of the present disclosure. FIG. 2 is a schematic diagram of an internal structure of an infrared sending and receiving assembly in the gimbal system according to Embodiment 1 of the present disclosure. FIG. 3 is a partially enlarged schematic diagram at “A” shown in FIG. 2. FIG. 4 is an exploded schematic diagram of a battle information interactive device in a gimbal system according to Embodiment 1 of the present disclosure. FIG. 5 is a schematic structural diagram of an indicator light in a gimbal system according to Embodiment 1 of the present disclosure. As shown in FIGS. 1-5, the gimbal system in some exemplary embodiments of the present disclosure can be used in a shooting battle, and includes a gimbal 1 and a battle information interactive device 2, where the battle information interactive device 2 is provided on an outer side surface of the gimbal 1 and may be used to perform at least one of the following operations: sending and receiving battle information and outputting special effects based on the battle information.

Specifically, the gimbal system may be provided on various fixed platforms or mobile platforms, e.g., a mobile remotely-controlled robot, or a carrier such as a remotely-controlled vehicle. The gimbal system may include a shooting device (not shown in the figures) used to point to a target and shoot the target with projectiles so as to battle or score shooting points. Since the carrier of the gimbal system is in a moving state in a simulated shooting battle, the shooting device needs to adjust its own shooting angle to ensure correctly aiming at a shooting target. In such a case, the shooting device is provided on the gimbal 1. The gimbal 1 has one or more rotating shafts, and thus can rotate about the one or more rotating shafts. When the gimbal 1 rotates, the shooting device will rotate about the rotating shafts driven by the gimbal 1 until it points to a correct shooting angle.

When performing a simulated shooting battle, in order to control the current simulated battle situation or to obtain battle information such as damages on the gimbal system and the carrier during the battle, it is necessary for the gimbal system and the outside to reliably obtain the battle information. For example, when battle information is interacted between multiple gimbal systems, if one or more gimbal systems cause simulated damages to the outside or perceive simulated damages from the outside (e.g., other gimbal systems), it is possible that each of the gimbal systems and the outside reliably obtain corresponding battle information synchronously, and then respond accordingly. When a corresponding gimbal system needs to issue special instructions or enter a special state, it may also output special effects through the battle information interactive device and use various special effects to display instructions and states. In this way, the battle information interactive device may be used to perform various interactive functions of the gimbal system during a simulated shooting battle, which effectively improves experience and fun of competitions.

During a battle, there may be multiple gimbal systems to combat simultaneously, and these gimbal systems may fight individually, or may be divided into multiple teams and battle in teams. When the gimbal systems interact with the outside for battle information, they may send and receive information and interact with other players (gimbal systems) in the same team, e.g., transmit help information (e.g., defense information), or they may also interact with competitors, e.g., transmit or receive attack information. In some exemplary embodiments, the interaction process of the battle information between gimbal systems from different teams is mainly used as an example for illustrative purpose.

In order to facilitate information sending and receiving or interaction with the outside, the battle information interactive device 2 is provided on an outer side surface of the gimbal 1, such that the battle information interactive device 2 is exposed from a side of the gimbal 1. Thus, neither signals for transmitting battle information nor signals for outputting special effects will be blocked by the structure of the gimbal system 1, and thus the reliability of battle information interaction is high. When information is transmitted to the outside, since the outer side of the battle information interactive device 2 is not covered, the information may be easily received by the outside. For example, users may more intuitively and easily observe the special effects output by the battle information interactive device 2 according to the battle information.

In some exemplary embodiments, in order to provide the battle information interactive device 2 and other components of the gimbal system on the gimbal 1, the gimbal 1 may include a shaft arm 11 which forms a mounting space for receiving at least a shooting device carried by the gimbal 1, and the battle information interactive device 2 can be arranged on an outer side surface of the shaft arm 1. When the shooting device is provided in the mounting space formed by the shaft arm 11, the shaft arm 11 can avoid the shooting device, so that the shooting device may rotate at a relatively large angle, thereby increasing the shooting angle range of the shooting device.

Specifically, an end portion of the shaft arm 1 may be connected to the shooting device through a rotating shaft. Then the shaft arm 1 may serve as a mounting basis for the battle information interactive device 2, and the battle information interactive device 2 may be provided on the outer side surface of the shaft arm 1, so that there is no obstacle between the battle information interactive device 2 and the outside, which thus facilitates interaction of battle information and outputting of special effects.

The gimbal 1 may be a two-shaft gimbal or a three-shaft gimbal, and correspondingly has shaft arms with different structures and in different positions. The battle information interactive device 2 may also be provided in different positions. For example, in some exemplary embodiments, the gimbal 1 is a two-shaft gimbal, as shown in FIGS. 1 and 2. The gimbal 1 is provided with a base that has thereon a motor 12 and other components, the base is provided with a rotating shaft along a vertical direction, so that the shaft arm 11 is configured to rotate about a yaw axis (Yaw axis) of the gimbal 1 and drive components provided on the shaft arm 11, such as the shooting device, to aim at different angles in a horizontal direction. The battle information interactive device 2 may be provided on the shaft arm 11 of the gimbal 1 that rotates about the Yaw axis of the gimbal 1, and thus rotates about the Yaw axis of the gimbal 1 along with the shaft arm 11. The shaft arm 11 may be provided with another rotating shaft through which the shooting device is connected to the shaft arm 11, so that the shooting device may rotate along a pitch axis (Pitch axis) to enable the shooting device to aim at different positions in the vertical direction to ensure that the shooting device can aim at different spatial directions.

In addition, in some exemplary embodiments, the gimbal 1 may be a three-shaft gimbal (not shown in the figures). In this case, the shaft arm for carrying the battle information interactive device may be configured to rotate about a roll axis (Roll axis) of the gimbal. Specifically, the gimbal may rotate about the Yaw axis relative to the base. Besides, the shaft arm in the gimbal may be configured to rotate about the roll axis, and may be further provided with a rotating shaft, so that the shooting device is connected with the shaft arm by the rotating shaft and may rotate along the pitch axis. The shaft arm rotating about the roll axis may be provided with a battle information interactive device, which may rotate about the roll axis of the gimbal along with the shaft arm.

It should be noted that the specific rotation axis around which the shaft arm 11 is configured to rotate needs to be determined according to the specific type and structure of the gimbal. For example, the shaft arm 11 may be configured to rotate about the pitch axis. However, the gimbal may not be limited to a two-shaft or three-shaft gimbal, but may be one having a different number of rotating shafts and a different structure.

In order to provide protection and stable support for the shooting device, in some exemplary embodiments, the shaft arm 11 may be a U-shaped shaft arm or a Y-shaped shaft arm. In other words, one end of the shaft arm 11 may have two end portions separated from each other, and these two end portions of the shaft arm 11 are respectively positioned on two sides of the shooting device. Thus the two end portions of the shaft arm 11 are both positioned on an outer side surface of the gimbal 1, and the shooting device is protected by the shaft arm 11.

Since a penetrating mounting space may be formed between the two end portions of the shaft arm 11, when the shooting device is provided between the two end portions of the shaft arm 11, the rotation of the shooting device is less restricted by the shaft arm 11, and thus may achieve a larger range.

In some exemplary embodiments, the two separated end portions of the shaft arm 11 may be symmetrically provided relative to the shooting device. Then the gimbal system has a relatively attractive and symmetrical structure.

In some exemplary embodiments, the battle information interactive device 2 may be positioned at the end portions of the shaft arm 11. Specifically, for a gimbal system having a gimbal structure as shown in FIGS. 1 and 2, the battle information interactive device 2 may be provided at the connection between the shaft arm 11 and the rotating shaft for rotating the shooting device about the pitch axis. In this way, since the end portions of the shaft arm 11 may be generally provided with driving elements such as a motor, arranging the battle information interactive device 2 in this position may facilitate appearance design based on the original design, thereby improving aesthetics. In addition, the end portion of the shaft arm 11 provided with a motor (i.e., for the end of the shaft arm 11 provided with two end portions, the motor may be provided at only one end portion of the two end portions) may form an outer surface with a relatively large area, so that the battle information interactive device 2 has a relatively plenty mounting space. Besides, the end portions of the shaft arm 11 are relatively high, are positioned more conspicuously and are not blocked, so that the signal sending and receiving and special effect outputting by the battle information interactive device 2 may be conducted conveniently.

Specifically, when the gimbal system and the carrier are in a simulated battle, the gimbal system and external competitors (e.g., other gimbal systems) usually maintain a certain battle distance. Thus, when transmitting battle information and outputting special effects according to the battle information to realize interaction, the battle information interactive device 2 may realize signal transmission and sensing in a non-contact manner. The battle information interactive device 2 may use infrared signals to send and receive battle information and output special effects, and the infrared signals may carry identity information of the gimbal system, so that other gimbal systems may identify the source of the battle information. In some exemplary embodiments, the battle information interactive device 2 may include an infrared sending and receiving assembly 21 for sending and receiving battle information. In addition, when the gimbal system needs to output special effects, a state display assembly 22 may be provided on the gimbal 1, and various sound and light effects may be used to achieve the special effect outputting for battle information. In this case, the battle information interactive device 2 may include at least one of the infrared sending and receiving assembly 21 and the state display assembly 22.

It should be noted that the state display assembly 22 is only one way for the gimbal system to output special effects. When the gimbal system is to achieve special effect outputting, it may use the state display assembly 22, or other components, e.g., a sound effect output system.

The specific structures, setting modes, and working mechanisms of the infrared sending and receiving assembly 21 and the state display assembly 22 will be respectively introduced in detail below.

Specifically, the infrared sending and receiving assembly 21 may transmit and receive infrared signals, and use the infrared signals to transmit battle information. Since the infrared signals have the characteristic of propagating along a straight line, there may be two or more infrared sending and receiving assemblies 21. These infrared sending and receiving assemblies 21 may be provided on the periphery of the gimbal 1 along a horizontal direction, and thus the gimbal system may receive or transmit infrared signals from or to objects (other gimbal systems) positioned in different directions around the horizontal direction and reliably transmit and interact the battle information.

Generally, when viewed in a horizontal peripheral direction, the ranges of angle in the right front and right rear directions of the gimbal system are relatively small, while the ranges of angle in the side directions are relatively large, which facilitate better observation of the outside. In some exemplary embodiment—there may be two infrared sending and receiving assemblies 21, and the two infrared sending and receiving assemblies 21 may be respectively arranged on two sides of the gimbal 1 along the horizontal direction. In this way, when the infrared sending and receiving assemblies 21 are arranged on two sides of the gimbal 1, they can cover a large range in the horizontally peripheral direction, besides, the infrared sending and receiving assemblies 21 may be less blocked by structures in the front of and the rear of the gimbal system, and thus the infrared sending and receiving assemblies 21 may have a good signal sending and receiving range. The horizontal direction herein refers to a reference direction when the gimbal system is mounted to the mobile platform in a normal operation. Specifically, the horizontal direction is parallel to the plane of the horizon, and perpendicular to the local gravity direction.

The infrared sending and receiving assemblies 21 may be positioned on an outer side surface of the gimbal 1. Thus, the infrared sending and receiving assemblies 21 may be less blocked by the gimbal system's own structure, thereby having a good field of view and a relatively large signal coverage, so that transmission and interaction of the battle interactive information become relatively reliable.

In some exemplary embodiments, the infrared sending and receiving assemblies 21 are positioned in the end portions of the shaft arm 11, which, on one hand, facilitates the setting of the infrared sending and receiving assemblies 21; on the other hand, allows the infrared sending and receiving assemblies 21 to ne less blocked, so as to ensure normal sending and receiving of the battle interactive information.

In order to complete the reception and transmission of the infrared signals, the interior of the infrared sending and receiving assemblies 21 may have components dedicated to receiving and transmitting the infrared signals. For example, in some examples, the structure of the infrared sending and receiving assembly, the infrared sending and receiving assembly 21 may specifically include an infrared transmitter 211 and an infrared receiver 212. The infrared transmitter 211 is used to transmit infrared signals carrying first battle information to the outside, such as other competitors in a battle, and the infrared receiver 212 is used to receive infrared signals carrying second battle information from the outside. In this way, the gimbal system in the simulated shooting battle may interact with the outside for the battle information through infrared signals. The first battle information and the second battle information are both included in the battle information, and the content and meaning contained by the first battle information and the second battle information may be the same or different. In an example, the first battle information may include attack information (e.g., transmitting attack information to competitors), defense information (e.g., transmitting defense information to teammates to prompt defense) and the like, and the second battle information may be used to indicate attack information from competitors or defense information from teammates, e.g., attacks, damages and the like from the competitors. It should be noted that the above examples are merely provided for illustrative purposes, and the content and meaning of the first battle information and the second battle information are not limited thereto.

In some exemplary embodiments, a transmission range and/or a reception range of the infrared sending and receiving assemblies 21 along the horizontal direction are both 360°. In this way, the gimbal system may realize an omnidirectional transmission and reception of the infrared signals in the horizontal peripheral directions.

When sending and receiving infrared signals, a single infrared transmitter 211 or a single infrared receiver 212 has a relatively limited signal transmission or reception angle range, and usually may cover only a narrow angle range. Therefore, when the infrared sending and receiving assemblies 21 of the gimbal system are sending and receiving infrared signals, in order to expand a signal coverage to enable the gimbal system to omnidirectionally transmit and receive infrared signals in the horizontal peripheral directions, in some exemplary embodiments, in each of the infrared sending and receiving assemblies 21, the numbers of infrared transmitters 211 and infrared receivers 212 are both at least two, and orientations of these infrared transmitters 211 are different, and orientations of these infrared receivers 212 are also different.

In this way, the infrared sending and receiving assemblies 21 are provided with multiple infrared transmitters 211 and multiple infrared receivers 212, and different infrared transmitters 211 and infrared receivers 212 are directed to different directions and angles, so that the multiple infrared transmitters 211 and multiple infrared receivers 212 having different orientations jointly cover a relatively large angle and range as a single infrared transmitter 211 and a single infrared receiver 212 cover a limited angle.

Since the infrared transmitters 211 and the infrared receivers 212 have different signal transmission or reception ranges, in each of the infrared sending and receiving assemblies 21, the infrared transmitters 211 and the infrared receivers 212 may have different numbers and setting angles. In addition, for a single infrared transmitter 211 or a single infrared receiver 212, when the model and specification of the infrared transmitter 211 or the infrared receiver 212 becomes different, the single infrared transmitter 211 or the single infrared receiver 212 may also have different signal angles and coverages. Thus, for the infrared transmitters 211 or infrared receivers 212 of different models and specifications, their numbers may also differ in individual infrared sending and receiving assemblies 21.

When there are multiple infrared transmitters 211 and multiple infrared receivers 212, the infrared transmitters 211 and the infrared receivers 212 in the infrared sending and receiving assemblies 21 may have a variety of arrangements and settings. The variety of arrangements and positions of the infrared transmitters 211 and the infrared receivers 212 in each of the infrared sending and receiving assemblies 21 will be depicted below in detail.

In some exemplary embodiments, at least two infrared transmitters 211 may be respectively positioned on two sides of at least two infrared receivers 212 along the horizontal direction. In this way, the infrared transmitters 211 and the infrared receivers 212 will be arranged on the periphery of the gimbal system along the horizontal direction. In other words, the infrared transmitters 211 are positioned outside of the infrared receivers 212 in the horizontal direction. When the infrared transmitters 211 are positioned on both sides of the infrared receivers 212, the infrared transmitters 211 would be less blocked by the infrared receivers 212, and thus may obtain a relatively large coverage, thereby improving reliability of transmission of infrared signals.

Besides, the infrared receivers 212 may also be positioned on both sides of the infrared transmitters 211 along the horizontal direction, so that the infrared receivers 212 may obtain a large coverage. The specific setting modes of the infrared transmitters 211 and the infrared receivers 212 may be adjusted accordingly based on specific specifications and numbers of the infrared receivers 212 and the infrared transmitters 211, which are not limited herein.

During a simulated battle, the gimbal system and its carrier may be positioned on the ground. Thus the gimbal system and other competitors in the outside are all positioned at the same or similar height. Thus, in one setting mode, orientations of at least one of the infrared transmitters 211 and the infrared receivers 212 may be set as along the horizontal direction.

Then since the orientations of all the infrared transmitters 211 or all the infrared receivers 212 are along the horizontal direction, there not spatial angle but only an angle in the horizontal direction between two adjacent infrared transmitters 211 or between two adjacent infrared receivers 212. In this way, the interval or angle between the infrared transmitters 211 and the infrared receivers 212 is relatively small, and thus a relatively large coverage in the horizontal direction may be achieved, and reliability of transmission and reception of the infrared signals may be improved.

It may be the case that the orientations of the infrared transmitters 211 may be all along the horizontal direction, the orientations of the infrared receivers 212 may be all along the horizontal direction, or the orientations of both the infrared transmitters 211 and the infrared receivers 212 may be along the horizontal direction, which is not limited herein.

Specifically, the number of the infrared transmitters 211 and the number of the infrared receivers 212 may be different. For example, the number of the infrared receivers 212 in a single infrared sending and receiving assembly 21 is three, e.g., an infrared receiver 212a, an infrared receiver 212b and an infrared receiver 212c, and the orientations of the three infrared receivers are respectively along a lateral front side of the gimbal 1, a lateral side of the gimbal 1, and a lateral rear side of the gimbal 1.

In this case, since the infrared sending and receiving assemblies 21 are generally positioned on both sides of the gimbal system in the horizontal direction, and the three infrared receivers in each of the infrared sending and receiving assemblies 21, i.e., the infrared receiver 212a, the infrared receiver 212b, and the infrared receiver 212c, may be arranged at an angle with each other and point to different ranges and angles from the gimbal 1 in the horizontal direction, so as to cover regions of the gimbal system on corresponding sides. Infrared signals may be received by the gimbal system in the horizontal peripheral direction through the cooperation of two or more infrared sending and receiving assemblies 21.

In some exemplary embodiments, the infrared receiver 212a, the infrared receiver 212b, and the infrared receiver 212c in each of the infrared sending and receiving assemblies 21 therebetween may fall within a specific angle range. For example, in three infrared receivers, an angle between the orientations of every two adjacent infrared receivers 212 may be greater than or equal to 70° and smaller than or equal to 110°. Thus the infrared receiver 212a, the infrared receiver 212b, and the infrared receiver 212c therebetween have proper spacing and angle, which ensures that the coverages of two adjacent infrared receivers 212 are connected to each other or have a certain overlapping region, thus the three infrared receivers 212 jointly cover a relatively large range.

Among the three infrared receivers 212 in each of the infrared sending and receiving assemblies 21, the orientations of every two adjacent infrared receivers 21 may be perpendicular or approximately perpendicular to each other. Thus, the three infrared receivers, i.e., the infrared receiver 212a, the infrared receiver 212b and the infrared receiver 212c, may jointly cover a range of about 180°.

In some exemplary embodiments, in a single infrared sending and receiving assembly 21, the number of the infrared transmitters 211 is two, which are, e.g., the infrared transmitter 211a and the infrared transmitter 211b, and an angle between orientations of the infrared transmitters 211a and 212b may be greater than or equal to 90° and smaller than or equal to 110°. Thus the infrared transmitter 211a and the infrared transmitter 211b therebetween will also have a suitable interval and angle to ensure that the infrared transmitters 211 have coverages connected to each other and jointly cover a relatively large range. In this way, the two infrared transmitters, i.e., the infrared transmitter 211a and the infrared transmitter 211b, may also jointly cover a range of approximately 180°. In an arrangement, an angle between the orientations of the two infrared transmitters 211 may be 100° or close to 100°.

In this way, by providing multiple infrared transmitters 211 and multiple infrared receivers 212 in the infrared sending and receiving assembly 21 and allowing different infrared transmitters 211 and different infrared receivers 212 to have different orientations, the multiple different infrared transmitters 211 and multiple infrared receivers 212 may jointly cover a relatively large range.

In order to provide the infrared transmitters 211 and the infrared receivers 212, the infrared sending and receiving assembly 21 may be further provided with other components and structures. In some examples, in some exemplary embodiments, the infrared sending and receiving assembly 21 further includes a circuit board 213 to which both the infrared transmitters 211 and the infrared receivers 212 are electrically connected. The circuit board 213 may supply power to the infrared transmitters 211 and the infrared receivers 212 and control signals, so that the infrared transmitters 211 and the infrared receivers 212 may perform normal signal sending and receiving. The circuit board 213 may be in different forms, e.g., in the form of a printed circuit board (PCB).

In addition, in some exemplary embodiments, the infrared sending and receiving assembly 21 may further includes a fixing frame 214, and thus the circuit board 213 may be arranged on the fixing frame 214. Besides, the infrared transmitters 211 and the infrared receivers 212 may be arranged on the circuit board 213 or the fixing frame 214; the fixing frame 214 itself may be connected to other structures in the infrared sending and receiving assembly 21 or the gimbal system to fix the infrared transmitters 211 and the infrared receivers 212 to the gimbal system.

In order to provide the fixing frame 214 or other structures of the infrared sending and receiving assembly 21 on the gimbal system, in some exemplary embodiments, a receiving slot 13 extending along the horizontal direction may be provided on an outer side surface of the gimbal 1, and the infrared sending and receiving assembly 21 may be positioned in the receiving slot 13. Since the receiving slot 13 extends along the horizontal direction, the length of the fixing frame 214 may also be along the horizontal direction. In this way, both the infrared transmitters 211 and the infrared receivers 212 may be arranged and configured along the horizontal direction.

In some exemplary embodiments, the infrared transmitters 211 and the infrared receivers 212 may point to different ranges in the horizontal direction, and thus the front end and rear end of the receiving slot 13 may have openings 131 through which at least part of the infrared transmitters 211 or at least part of the infrared receivers 212 may be exposed to the front side and the rear side of the gimbal 1. By providing avoiding structures such as the openings 131, the receiving slot 13 will not block signal transmission of the infrared transmitters 211 and the infrared receivers 212 in the horizontal direction, thereby ensuring that the infrared sending and receiving assembly 21 has a relatively large signal sending and receiving range.

In addition, in some exemplary embodiments, a slot wall of the receiving slot 13 may protrude toward an outer side of the gimbal 1 in the horizontal direction, and a protruding height of a middle section of the slot wall of the receiving slot may be greater than a protruding height of an end portion of the slot wall of the receiving slot 13. In this way, the height of the slot wall of the receiving slot 13 can match the positions and angles of the infrared transmitters 211 and the infrared receivers 212 in the infrared sending and receiving assembly 21 so as to prevent the end portion of the slot wall of the receiving slot 13 from affecting the signal sending and receiving range of the infrared sending and receiving assembly 21 while protecting the infrared sending and receiving assembly 21.

In order to shield the infrared transmitters 211 and the infrared receivers 212 to prevent the exposed infrared transmitters 211 and the infrared receivers 212 from affecting the overall appearance of the gimbal system, in some exemplary embodiments, the gimbal system may further include a cover board 14 that allows infrared light transmission to cover the receiving slot 13. Thus, components in the infrared sending and receiving assembly 21 such as the infrared transmitters 211, the infrared receivers 212 and the circuit board 213, may all be shielded by the cover board 14. The cover board 14 may be made of a material that only allows the transmission of infrared rays, and thus may shield structures inside the receiving slot 13 to improve the aesthetics of the gimbal 1, while allowing the infrared sending and receiving assembly 21 to retain its normal signal sending and receiving functions.

When the cover board 14 is used to shield the infrared sending and receiving assembly 21, in order to prevent structures such as the cover plate 14 from affecting the signal sending and receiving range of the infrared sending and receiving assembly 21, in some exemplary embodiments, the cover board 14 may protrude toward an outer side of the gimbal 1. Moreover, the cover board 14 may have visible regions along the front and rear directions of the gimbal 1. In this way, a partial region of the cover board 14 can be seen no matter viewed from the lateral side of the gimbal 1 or from the front or rear side of the gimbal 1. Thus structures in the front or rear of the gimbal 1 will not shield the infrared sending and receiving assembly 21 positioned on an inner side of the cover board 14, and the infrared transmitters 211 or the infrared receivers 212 may transmit or receive infrared signals through this partial region so as to realize a relatively large signal coverage.

In order to allow the gimbal system and the carrier to intuitively output the battle information during a simulated shooting battle, the battle state interactive device 2 may further include a state display assembly 22, which is used to display part of the special effects and the like using, sound and light means, etc., according to the battle information transmitted by the gimbal system and the battle information received from other competitors, or for a special operation or a special state of the state display assembly 22. The specific structure and functions of the state display assembly 22 will be depicted below in detail.

The state display assembly 22 displaying battle information mainly includes, detecting attacks received and damages suffered by the gimbal system, and displaying the battle information including the attacks and damages. When the state display assembly 22 displays the battle state of the gimbal system, the battle information may include one of the following or a combination thereof: a blood volume of the gimbal system during the battle, and whether the gimbal system is attacked by balls during the battle.

In a battle, the gimbal system may have a simulated blood volume. When it is attacked by balls or other attack means, the simulated blood volume of the gimbal system will be reduced. Thus the state display assembly 22 may display a blood volume of the gimbal system in real time during the battle. Besides, when the gimbal system is attacked by a ball, the state display assembly 22 may display it so that operators and audience may know about the situation. In addition, the battle state displayed by the state display assembly 22 may further include whether the gimbal system is in a special state (a special skill is released or the blood volume drops to a certain limit, etc.).

The display component 22 may display the battle information using different means, such as light and sound effects. The state display assembly 22 is used in such a way as to display a current state of the gimbal system during a battle, so that operators, audience and the like may easily obtain the current battle state of the gimbal system in order to clearly learn the battle situation of the simulated battle.

In some exemplary embodiments, the state display assembly 22 may specifically include one or more indicator lights 221 to display corresponding battle information by changing a light-emission state.

The indicator lights 221 may have one or more of the following variable light-emission states: colors of the indicator lights 221, light-emission frequencies of the indicator lights 221, brightness of the indicator lights 221, light-emission duration of the indicator lights 221, and an area of a light-emission region of the indicator lights 221.

Specifically, the indicator lights 221 may have a variety of light-emission states. For example, the indicator lights 221 may be multi-color indicator lights, and may emit light of different colors to indicate different battle states. For example, when the indicator lights 221 emit cyan light, it may indicate that the gimbal system is in a connection mode, or when the indicator lights 221 emit red and blue light, it may indicate that the gimbal system is in a ready state.

Alternatively, the indicator lights 221 may also have multiple light-emission regions, and different light-emission regions are used to indicate different battle information. Or, the indicator lights 221 may also have different states, such as constant on, flashing, etc., and when the indicator lights 221 are flashing, they may have different flashing frequencies. Thus, different battle states may be indicated by the constant on/flashing state and flashing frequencies of the indicator lights 221. For example, in the battle, the indicator lights 221 may flash at a high frequency when the blood volume of the gimbal system is low (lower than 25%), or when the gimbal system is in a special skill state (invincible, or releasing a group attack skill). Besides, the indicator lights 221 may also have different brightness, and corresponding battle states of the gimbal system may be distinguished according to the brightness. The indicator lights 221 may use different single light-emission states and combinations of multiple light-emission states to indicate different information, which will not be discussed herein.

In this way, the battle state of the gimbal system is displayed by the indicator lights 221 and other devices. When the light-emission state of the indicator lights 221 changes, it may be intuitively and clearly observed by the operators of the gimbal system or the audience, and thus the operators and the audience may easily know about the current situation of the simulated battle, which facilitates operations by the operators, and enhance the fun of the simulated battle.

In some exemplary embodiments, the indicator lights 221 may have at least two independent light-emission regions. When the indicator lights 221 emit light, different battle information may be indicated by controlling different light-emission regions to respectively emit light independently. The light-emission states of each of the light-emission regions may include one or more of the following: a constant on state, a constant off state, and a flashing state. Different battle information may be indicated according to different light-emission states of each of the light-emission regions. Since the indicator lights 221 are divided into different light-emission regions, the indicator lights may be used to indicate different information according to different light-emission states of each of the light-emission regions. For example, only a particular light-emission region in the indicator lights 221 may be turned on or off, and this particular light-emission region is used to indicate particular battle information. Or, the light-emission regions in the indicator lights 221 are turned on or off in a particular sequence to achieve a marquee effect, and the like.

To allow the audience from different sides of the gimbal system to easily see the battle information on the gimbal system, in some exemplary embodiments, there are at least two sets of indicator lights 221, and these two sets of indicator lights 221 are respectively provided on the periphery of the gimbal 1 along the horizontal direction. In this way, there are the indicator lights 221 in all the directions of the gimbal system for indication, which is convenient for the operators and the audience to view the battle state of the gimbal system in real time.

Further, in some exemplary embodiments, there may be two sets of indicator lights 221, and these two sets of indicator lights 221 are respectively provided on two sides of the gimbal along the horizontal direction. In this way, there are the indicator lights 221 on both sides of the gimbal system for indication, which is convenient for the operators and the audience to view the battle state of the gimbal system in real time.

In some exemplary embodiments, similar to the infrared sending and receiving assembly 21, the indicator lights 221 may also be provided at the end portions of the shaft arm 11. Generally the end portions of the shaft arm 11 may be provided with driving elements such as a motor, and thus providing the indicator lights 221 at this location may facilitate coordinating and unifying the appearance, thereby improving the aesthetics. In addition, since the connection between the shaft arm 11 and the rotating shaft is in a relatively high position and the end portions of the shaft arm 11 provided with the rotating shaft may generally form an outer surface with a relatively large area, the indicator lights 221 are more conspicuous, and thus having better indicating effects when the indicator lights 221 are provided at the connection between the shaft arm 11 and the rotating shaft.

In this case, the indicator lights 221 are positioned at the end portions of the shaft arm 11; accordingly, in some examples, the indicator lights 221 may be ring-shaped, and surround an outer side of the end portions of the rotating shaft (e.g., the pitch axis). Since the indicator lights 221 are a ring-shaped light band, the indicator lights 221 may occupy a large area of the outer surface of the gimbal 1 to have good indicating effects. Meanwhile, a ring formed by the indicator lights 221 surrounds an outer side of the pitch axis, and thus coordinated visual effects may be achieved between the indicator lights 221 and the shaft arm 11 to enable the gimbal system to have good aesthetics.

Specifically, the ring-shaped indicator lights 221 may include one or more light band segments. For example, the indicator lights 221 may include one ring-shaped light band segment or multiple light band segments that jointly form a ring. In order to facilitate manufacturing and assembling, in some exemplary embodiments, the indicator lights 221 may include at least two light band segments 222 which are all arc-shaped, and the light band segments 222 jointly form a ring.

In some exemplary embodiments, in some exemplary embodiments, the light band segments 222 in the indicator lights 221 may specifically include a first light band segment 222a and a second light band segment 222b provided respectively on an upper side and a lower side of the infrared sending and receiving assembly 21. In this way, the two light band segments 222 may be arranged symmetrically relative to the infrared sending and receiving assembly 21 to organically combine the infrared sending and receiving assembly 21 and the indicator lights 221, so as to effectively use the limited mounting space on the gimbal and improve the aesthetics of the gimbal system.

In order to indicate different battle states, in some examples, each of the light band segments 222 may be divided into at least two light-emission regions, and thus each of the light band segments 222 may control its various light-emission regions to emit light independently to indicate different battle information. The specific manner that the light band segments 222 are divided into multiple different light-emission regions has been exemplified in the above embodiments, and will not be discussed herein.

In order to divide a light band segment 222 into multiple light-emission regions, in some examples, the light band segment 222 may include at least two LED lights 2221 provided spaced apart, and a light isolation portion 2222 may be provided between every two adjacent LED lights 2221. The light isolation portion 2222 may isolate two adjacent LED lights 2221 from each other, so that each of the LED lights 2221 is positioned in an independent light-emission region, and light emitted from other LED lights 2221 is isolated by the light isolation portion 2222 and will not affect the light-emission region of this LED light 2221. In this way, independent light emissions of different light-emission regions may be realized.

In some exemplary embodiments, each of the light band segments 222 may be divided by the light isolation portion 2222 into four light-emission regions independent from each other.

The gimbal system in some exemplary embodiments may be used for a shooting battle, and specifically includes a gimbal and a battle information interactive device, where the battle information interactive device may be provided on an outer side surface of the gimbal to perform one or more of the following operations: sending and receiving battle information, and outputting special effects based on the battle information. In this way, the battle information interactive device may be used to provide interactive functions of the gimbal system in a simulated shooting battle, which effectively improves the experience and fun of competitions. In addition, since the outer side of the battle interactive device is not shielded, information sending and receiving and/or special effect output may be achieved conveniently from and/or by the outside.

Embodiment 2 of the present disclosure further provides a mobile platform. The mobile platform provided in some exemplary embodiments specifically includes a platform main body and the gimbal system mentioned in the above embodiment provided on the platform main body. The specific structure, functions and working mechanisms of the gimbal system have been depicted in detail in Embodiment 1, and will not be discussed herein.

Specifically, the mobile platform in some exemplary embodiments may be used in simulated shooting battles and other competitions, and can achieve scoring and competitive effects by shooting balls to targets or competitors. Since the gimbal system of the mobile platform includes a battle information interactive device, the functions of damage detection and displaying battle states may be realized effectively and reliably, thereby effectively improving the enjoyment and fun of competitions.

The mobile platform may be vehicles of different types. For example, the mobile platform may be a ground mobile robot that fights a simulated shooting battle on the ground. Or, the mobile platform may be an aircraft that can fight in the sky.

In some exemplary embodiments, the mobile platform specifically includes a platform main body and a gimbal system provided on the platform main body, where the gimbal system is used for a shooting battle and specifically includes a gimbal and a battle information interactive device provided on an outer side surface of the gimbal and configured to perform one or more of the following operations: sending and receiving battle information, and outputting special effects based on the battle information. In this way, the mobile platform may use the battle information interactive device to fulfill interactive functions of the gimbal system during the simulated shooting battle, which effectively improves the experience and fun of competitions. In addition, the outer side of the battle interactive device is not shielded, and information sending and receiving and/or special effect outputting may be achieved conveniently from and/or by the outside.

Moreover, Embodiment 3 of the present disclosure further provides a battle system including at least two teams, each of which includes at least one mobile platform as depicted in the above exemplary embodiments. The mobile platform may perform at least one of the following operations through the battle information interactive device: sending and receiving battle information, and outputting special effects based on the battle information. The specific structures, functions, and working principles of the mobile platform and the battle information interactive device in some exemplary embodiments have been depicted in detail in the above embodiments, and will not be discussed herein.

Each mobile platform in the battle system may be divided into multiple teams, and the teams may have shooting competitions, or the like. In a battle, when each gimbal system interacts with the outside for battle information, it may send and receive information and interact with other gimbal systems of the same team, such as transmit cooperation information, help information or team formation instructions, and it may also interact with competitors, such as transmit or receive attack information. Accordingly, each gimbal system may interact with members in the same team or competitors in other teams through the battle information interactive device, thereby realizing an interaction of the battle information. Certainly the gimbal system in each mobile platform may also output special effects according to the send and received battle information, so that the outside may intuitively know about the battle situation, thus the man-machine interaction is enhanced.

The battle system provided in some exemplary embodiments includes at least two teams, each of which includes at least one mobile platform as depicted in the above embodiments, and the at least one mobile platform may perform at least one of the following operations through the battle information interactive device: sending and receiving battle information, and outputting special effects according to the battle information. In this way, the mobile platform may use the battle information interactive device to fulfill interactive functions of the gimbal system during the simulated shooting battle, which effectively improves the experience and fun of competitions. In addition, since the outer side of the battle interactive device is not shielded, the information sending and receiving and/or special effect outputting may be achieved conveniently from and/or by the outside.

Finally, although advantages associated with some embodiments of the present disclosure have been depicted in the context of these embodiments, other embodiments may also have these advantages. Not each of the described embodiments depicts in detail all of the advantages of the present disclosure, and the advantages objectively achieved by technical features in the embodiments shall be regarded as advantages of the present disclosure distinguished from the existing technology, and fall into the scope of protection of the present disclosure.

What is claimed is:

1. A gimbal system for a shooting battle, comprising:
a gimbal; and
a battle information interactive device arranged on an outer side surface of the gimbal to send and receive battle information and output special effects based on the battle information.

2. The gimbal system according to claim 1, wherein the battle information interactive device includes
at least one infrared sending and receiving assembly to send and receive the battle information, and
a state display assembly to output special effects based on the battle information.

3. The gimbal system according to claim 2, wherein the gimbal includes a shaft arm forming a mounting space to at least receive a shooting device carried by the gimbal, and
the battle information interactive device is arranged on an outer side surface of the shaft arm.

4. The gimbal system according to claim 3, wherein the shaft arm is a U-shaped shaft arm or a Y-shaped shaft arm; and
the at least one infrared sending and receiving assembly and the state display assembly are positioned respectively on end portions of the shaft arm.

5. The gimbal system according to claim 2, wherein the at least one infrared sending and receiving assembly includes at least two infrared sending and receiving assemblies, which are respectively arranged on a periphery of the gimbal along a horizontal direction.

6. The gimbal system according to claim 5, wherein a transmission range and a reception range of the at least two infrared sending and receiving assemblies along the horizontal direction are both 360°.

7. The gimbal system according to claim 5, wherein the at least two infrared sending and receiving assemblies include:
at least one infrared transmitter to transmit, infrared signals carrying first battle information, and
at least one infrared receiver to receive infrared signals carrying second battle information; and
the battle information includes the first battle information and the second battle information.

8. The gimbal system according to claim 7, wherein each of the at least two infrared sending and receiving assemblies includes:
two or more infrared transmitters with different orientations with respect to direction, and
two or more infrared receivers with different orientations in the horizontal direction, and
the two or more infrared transmitters are positioned on two sides of the two or more infrared receivers along the horizontal direction.

9. The gimbal system according to claim 8, wherein each of the infrared sending and receiving assemblies includes: three infrared receivers, and
orientations of the three infrared receivers are respectively set along a lateral front side of the gimbal, a lateral side of the gimbal, and a lateral rear side of the gimbal, and
an angle between orientations of any two adjacent infrared receivers is greater than or equal to 70° and smaller than or equal to 110°.

10. The gimbal system according to claim 9, wherein each of the infrared sending and receiving assemblies includes two infrared transmitters, and
an angle between orientations of the two infrared transmitters is greater than or equal to 90° and smaller than or equal to 110°.

11. The gimbal system according to claim 7, wherein the at least two infrared sending and receiving assemblies further include a circuit board to which the at least one infrared transmitter and the at least one infrared receiver are respectively electrically connected;
the at least two infrared sending and receiving assemblies further include a fixing frame on which the circuit board is arranged, and the at least one infrared transmitter and the at least one infrared receiver are all arranged on the circuit board or the fixing frame.

12. The gimbal system according to claim 2, wherein the outer side surface of the gimbal includes a receiving slot extending along a horizontal direction, and the at least one infrared sending and receiving assembly is arranged in the receiving slot.

13. The gimbal system according to claim 12, wherein a front end and a rear end of the receiving slot include openings through which at least part of an infrared transmitter or at least part of the infrared receivers in the infrared sending and receiving assemblies are exposed to a front side and a rear side of the gimbal;
a slot wall of the receiving slot protrudes toward an outer side of the gimbal along the horizontal direction, and a protruding height of a middle section of the slot wall of the receiving slot is greater than a protruding height of an end portion of the slot wall of the receiving slot.

14. The gimbal system according to claim 12, further comprising a cover board that
allows transmission of infrared light, and the cover board,
covers the receiving slot,
protrudes toward an outer side of the gimbal, and
includes visible regions along a front direction and a rear direction of the gimbal.

15. The gimbal system according to claim 2, wherein the state display assembly includes at least one indicator light to display corresponding battle information by changing light-emission states thereof.

16. The gimbal system according to claim 15, wherein the at least one indicator light has one or more of the following variable light-emission states:
colors of the at least one indicator light,
light-emission frequencies of the at least one indicator light,
brightness of the at least one indicator light,
light-emission durations of the at least one indicator light, and
light-emission regions of the at least one indicator light.

17. The gimbal system according to claim 15, wherein the at least one indicator light is ring-shaped, and surround the outer side surface of the gimbal;
the at least one indicator light each includes at least two light band segments which are arc-shaped, and
the at least two light band segments jointly form a ring, and each of the light band segments is divided into at least two light-emission regions.

18. A mobile platform, comprising a platform main body; and
a gimbal system on the platform main body,
wherein the gimbal system includes a gimbal and a battle information interactive
device, and the battle information interactive device is arranged on an outer side surface of the gimbal to send and receive battle information or output special effects based on the battle information.

19. The mobile platform according to claim 18, wherein the battle information interactive device includes at least one infrared sending and receiving assembly to send and receive the battle information and a state display assembly to output special effects based on the battle information.

20. A battle system, comprising:
at least two teams, each of which includes at least one mobile platform that includes a platform main body, and a gimbal system on the platform main body;
the gimbal system including a gimbal and a battle information interactive device;
the battle information interactive device being arranged on an outer side surface of the gimbal to send and receive battle information or output special effects based on the battle information between mobile platforms.
